(19) United States
(12) Patent Application Publication
(10) Pub. No.: US 2026/0302624 A1
(43) Pub. Date: Oct. 1, 2026

(54) Near Field On Far Field Integrated Antennas

(71) Applicant: Zebra Technologies Corporation, Lincolnshire, IL (US)

(72) Inventors: Mark W. Duron, Mastic, NY (US); Rehan K. Jaffri, Tarrytown, NY (US); Sean Connolly, Stony Brook, NY (US)

(21) Appl. No.: 19/096,135

(22) Filed: Mar. 31, 2025

(51) Int. Cl. H01Q 9/04; G06K 7/10; H01Q 1/22; H01Q 7/00

(52) U.S. Cl. CPC H01Q 9/0414; G06K 7/10297; H01Q 1/2216; H01Q 7/00

(57) ABSTRACT

Techniques for combining functionalities of a near field antenna and far field antenna in an integrated or “dual purpose” antenna structure are provided. The integrated antenna may reduce the combined volume and weight of the combined near field antenna and far field antenna, as compared to traditional implementations wherein the antennas are separate, discrete structures. In embodiments, a controller switches operation of the integrated antenna between a near field mode and far field mode, facilitating various applications. Moreover, techniques are provided to reduce interference within the integrated antenna between the near field and far field antennas, particularly by geometrically aligning a drive point of the near field antenna with a null point of the far field antenna.

### FIELD OF THE DISCLOSURE

The present disclosure relates to antenna hardware, and more particularly, to combinations of near field antenna and far field antenna hardware in RFID readers and applications thereof.

### BACKGROUND

Traditionally, a variety of applications and industries employ near field and/or far field communicating antennas, for example to allow a device to track locations of radio-frequency identification (RFID) tags corresponding to persons and/or items in an environment.

### SUMMARY

In some aspects, an antenna is provided. The antenna may include a far field patch antenna having a planar surface. The far field patch antenna may include a first antenna drive point at a first position on the planar surface, and a null point at a second position on the planar surface. The antenna may also include a printed circuit board (PCB) disposed on the planar surface of the far field patch antenna. The antenna may still further include a near field antenna disposed on the PCB, the near field antenna comprising a second antenna drive point at a third position on the planar surface, wherein the third position on the planar surface is aligned with the second position. The antenna may be configured to switch between a first mode corresponding to operation of the far field patch antenna and a second mode corresponding to operation of the near field antenna.

In some aspects, the antenna is implemented in an electromagnetic reader device capable of both near field and far field signal detection. The electromagnetic reader device may be arranged to exclude each of a standalone far field antenna and a standalone near field antenna.

In some aspects, the near field antenna comprises a microstrip transmission coil originating from the second drive point.

In some aspects, the antenna is operatively coupled to a controller configured to switch operation of the antenna between the first mode corresponding to operation of the far field patch antenna and the second mode corresponding to operation of the near field antenna. More particularly, in some aspects, the controller may be configured to switch the operation of the antenna at predetermined time intervals. Additionally or alternatively, in some aspects, the first mode of operation may comprise identification of an entity as being within a space, and the second mode of operation may comprise identification of the entity as being within a portion of the space. Even more particularly, in some aspects, the controller may be configured to switch to the second mode of operation responsive to the identification occurring in the first mode of operation.

In some aspects, an RFID reader device is provided. The RFID reader device may include a far field patch antenna having a planar surface. The far field patch antenna may comprise a first antenna drive point at a first position on the planar surface, and a null point at a second position on the planar surface. The RFID reader device may also include a near field antenna disposed on the PCB, the near field antenna comprising a second antenna drive point at a third position on the planar surface, with the third position on the planar surface being aligned with the second position. The RFID reader device may still further include a controller comprising a processor and a memory. The memory may store instructions that, when executed, cause the controller to switch operation of the RFID reader between a first mode corresponding to operation of the far field patch antenna and a second mode corresponding to operation of the near field antenna.

In some aspects, the RFID reader may be arranged to exclude each of a standalone far field antenna and a standalone near field antenna.

In some aspects, the near field antenna may include a microstrip transmission coil originating from the second drive point.

In some aspects, the controller may be configured to switch the operation of the antenna at predetermined time intervals.

In some aspects, the first mode of operation may include identification of an entity as being within a space, and the second mode of operation may include identification of the entity as being within a portion of the space. More particularly, in some aspects, the instructions, when executed be the processor, may cause first mode of operation comprises identification of an entity as being within a space, and wherein the second mode of operation comprises identification of the entity as being within a portion of the space. Additionally or alternatively, in some aspects the instructions, when executed by the processor, may also cause the controller to, subsequent to switching to the second mode of operation, (i) revert the RFID reader to the first mode of operation, and/or (ii) determine that the RFID reader did not detect the entity while operating in the second mode of operation before reverting to the first mode of operation. Still more particularly, in some of these aspects, the RFID reader may be operatively coupled to a display, and the instructions, when executed by the processor, may cause the display to provide a warning regarding the determination that the RFID reader did not detect the entity while operating in the second mode of operation.

In some aspects, the operation of the RFID reader in the first mode may cause energization of an RFID tag via the far field patch antenna, and the operation of the near field antenna in the second mode may include reading the RFID tag via the near field antenna after the energization via the far field patch antenna.

In some aspects, a method of manufacturing an antenna is provided. The method may include obtaining a far field patch antenna having a planar surface. The far field patch antenna may include a first antenna drive point at a first position on the planar surface, and a first antenna drive point at a first position on the planar surface. The method may also include a first antenna drive point at a first position on the planar surface. The method may still also include applying a near field antenna upon the PCB. The near field antenna may include a second antenna drive point at a third position on the planar surface, wherein the third position on the planar surface is aligned with the second position.

In some aspects, the method further includes operatively coupling the antenna to a controller, which may be configured to switch operation of the antenna between a first mode corresponding to operation of the far field patch antenna and a second mode corresponding to operation of the near field antenna.

In some aspects, the method further includes configuring the antenna to switch between a first mode corresponding to operation of the far field patch antenna and a second mode corresponding to operation of the near field antenna.

In some aspects, the near field antenna has a resistance of 50 ohms.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts a top view of an antenna including both a near field antenna and far field antenna, in accordance with various embodiments described herein.

FIG. 2 depicts a profile (side) view of the antenna from FIG. 1, in accordance with various embodiments described herein.

FIG. 3 depicts a magnified top view of a portion of the antenna from FIGS. 1 and 2, in accordance with various embodiments described herein.

FIG. 4 depicts a block diagram of an example electromagnetic reader device, in accordance with various embodiments described herein.

FIG. 5 depicts a block diagram of an example method, in accordance with various embodiments described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A near field is generally considered to be a shorter distance from a radiating antenna, compared to a far field. Although traditional considerations of distance of the near field and far field may vary, the near field is often considered as extending up to 1 λ from the radiating antenna, where λ is the wavelength of the radiation emitted by the antenna. The near field may, for example, extend up to approximately 18 inches from the radiating antenna. Near field communications typically operate at lower power compared to far field communications, but the reliability of near field communications typically declines sharply past a known near field range. Far field communications, may extend much further than near field communications. A far field range is often considered as beginning at a distance of 2*D\hat{ }2/λ, where D is a largest dimension of a radiating antenna. Far field communications may extend, for example, up to a distance of approximately 80 feet or further from the radiating antenna. As such, various applications traditionally use near field communications to detect objects such as RFID tags in the immediate vicinity of a scanning device (e.g., a handheld RFID reader), or far field communications to detect objects in an expansive environment in which the scanning device is located.

Given the relative advantages and disadvantages of near field and far field communications, various applications and industries may desire to utilize both near field and far field communications, and more particularly, enable a scanning device to utilize both near field and far field communications. However, implementing both near field and far field communications in one device traditionally requires disposing two discrete, separate radiating antenna structures in the device. The combined weight and volume of these two antenna structures disadvantageously increases the volume and weight of the scanning device, and moreover, presents interference when the two antenna structures operate in close special(e.g., very near or adjacent) and/or temporal proximity.

In consideration of these challenges, the present disclosure describes an integrated or “dual purpose” antenna that combines both a near field antenna and far field antenna in a single, joint structure, reducing the volume and weight required by the combined antennas. In embodiments, a controller may switch the antenna to operate alternatively in a near field mode and a far field mode, to facilitate the detection of objects positioned at nearer and farther distances from a device, respectively. Moreover, the integrated antenna proposed herein mitigates or eliminates interference between the near field and far field antennas, via a particular arrangement of the near field and far field antennas, where a drive point of the near field antenna is geometrically aligned with a null point of the far field antenna. The arrangement and control of the integrated antenna may facilitate a number of applications, examples of which will be provided herein.

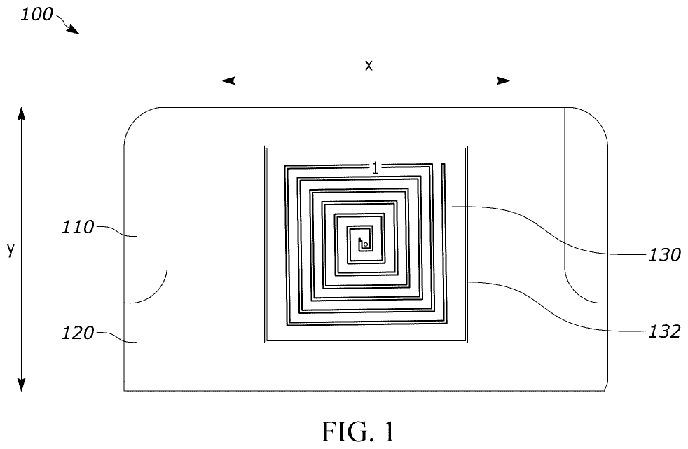

FIGS. 1-3 depict various views of an example integrated antenna 100, in accordance with some embodiments. It should be appreciated that dimensions of the integrated antenna 100 as depicted in FIGS. 1-3 are not necessarily to scale, and moreover, various dimensions and arrangements may be contemplated in various embodiments.

Beginning of FIG. 1, a top (overhead) view of the integrated antenna 100 is provided. From the top view of FIG. 1, a substantially planar surface of the integrated antenna 100 is visible, the planar surfaced being defined by a plane in directions (axes) x and y.

The integrated antenna 100 includes a far field antenna 110 (e.g., a far field patch antenna), which has a substantially planar surface. That is, a thickness of the far field antenna 110 may be negligible compared to a size of the far field antenna in the x and y directions. For example, the far field antenna 110 may have a thickness of approximately 3.2 millimeters (mm), or even less. The far field patch antenna 110 may include an integrated circuit and a transmitting element, and may be configured to emit an electromagnetic field in a direction perpendicular to the planar surface (also referred to herein as “the xy plane”). This perpendicular direction can be expressed as a third, z direction that extends toward (and/or away from) the implied position of the viewer of FIG. 1.

Layered on top of the far field antenna 110 is a printed circuit board (PCB) 120 (or other insulating element) configured to electrically insulate the far field antenna 110 from a near field antenna 130 layered on top of the PCB 120 (i.e., further above the far field antenna 110, on opposing sides of the PCB 120). Each of the PCB 120 and the near field antenna 130, like the far field antenna 110, may be substantially planar, having negligible thickness in the z direction compared to size in the x and y directions. For example, the near field antenna 130 may have a thickness of approximately 3.2 mm or less, and the PCB 120 may have a thickness range of approximately 0.5 mm to 2.0 mm. As depicted in FIG. 1, from the implied position of the viewer, the PCB 120 covers some but not all of the far field antenna 110, and the near field antenna 130 covers some but not all of the PCB 120. In some embodiments, the far field antenna 110 and/or near field antenna 130 are mounted into bottom and/or top sides of the PCB 120, respectively. It should be appreciated that this depiction is provided for ease of illustration of the components of the integrated antenna 100, and various other layering arrangements may be envisioned.

The near field antenna 130 may, for example, be a patch antenna such as a microstrip antenna or other inductive antenna, which may include an integrated circuit connected to a transmitter and/or receiver by way of a microstrip transmission coil 132. The microstrip transmission coil 132 may have a resistance of 50 Ohms, or another suitable value. It should be appreciated that other types of antennas may be envisioned, in various embodiments. The near field antenna 130, like the far field antenna 110, may be configured to emit radiation to establish a field in the z direction perpendicular to the xy plane. That field, for the near field antenna 130, is a magnetic field or a primarily magnetic field (i.e., very week electromagnetic field), whereas the far field antenna 110 generates an electromagnetic field in the far field. In embodiments, when an RFID tag, for example, comes into the magnetic field of the near field antenna 130, the magnetic field may energize the RFID tag to enable the RFID tag to communicate identifying information to the near field antenna 130 (and/or to a controller operatively coupled thereto).

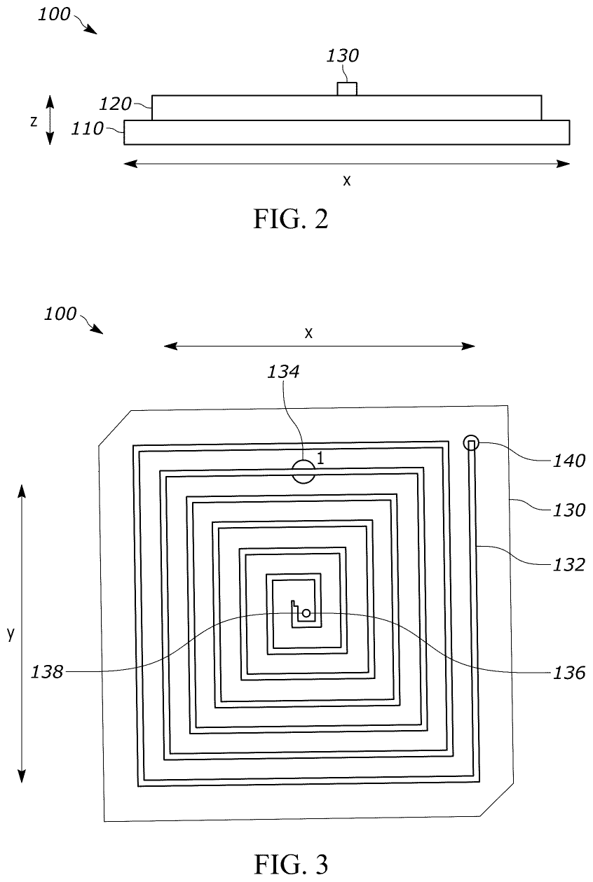

Moving to FIG. 2, an alternate profile (side) view of the integrated antenna 100 is provided. The profile view of FIG. 2 illustrates example layering of the far field patch antenna 110, PCB 120, and near field antenna 130 in the z direction, with a substantially larger dimension of each component extending in the x direction (and/or the y direction, which is not depicted in FIG. 2). The comparatively narrow depiction of the near field antenna 130 in FIG. 2 represents the microstrip transmission coil 132 from FIG. 1, which has a narrow width at any point along the extension thereof.

FIG. 3 illustrates a magnified view of the integrated antenna 100 is provided depicting the near field antenna 130. It may be presumed that beneath the near field antenna 130 from the perspective of the viewer of FIG. 3 are the PCB 120 and the far field antenna 110.

The far field antenna 110 has a drive point 134 on a first position relative to the xy plane, and a null point 136 at a second position relative to the xy plane. That is, although the drive point 134 and null point 136 may in actuality be beneath the near field antenna 130 in the z direction, a position of the far field antenna 110 may be compared to a position of the near field antenna 130 (and/or the PCB 120) in terms of coordinates in the x and y directions. The null point 136 is a point in the x and y directions where electromagnetic energy from the far field antenna 110 does not change (whereas electromagnetic energy from the far field antenna 110 may vary at all other points relative to the x and y directions).

The near field antenna 130 may include the microstrip transmission coil 132 originating from a drive point 138 of the near field antenna 130 and extending to a termination point 140. The position of the drive point 138 is aligned with the position of the null point 136 relative to the xy plane, and hence, the drive point 138 and null point 136 are illustrated as a single dowel (though it should be understood that positions of the two elements may differ in the z direction). By driving the near field antenna 130 from the position of the null point 136, the integrated antenna 100 prevents interference between the magnetic field of the near field antenna 130 and the electromagnetic field of the far field antenna 110 when said antennas are operated in close temporal proximity (e.g., when the near field antenna 130 activates immediately after the far field antenna 110, or vice versa). By implementing the integrated antenna 100 as configured, a device containing the integrated antenna 100 (e.g., an electromagnetic reader device such as an RFID reader) can implement near field and far field communications without requiring each of a standalone near field antenna and standalone far field antenna (that is, discrete antenna structures that include one but not both of near field and far field capabilities).

It should be appreciated that the arrangement of the integrated antenna 100 as shown in FIGS. 1-3 is provided as one example, and that other arrangements may be possible, in various embodiments. For example, in at least one such embodiment, the layering of the far field antenna 110, PCB 120, and near field antenna 130 is reversed, with the PCB 120 layered on top of the near field antenna 130 and the far field antenna 110 layered further on top of the PCB 120.

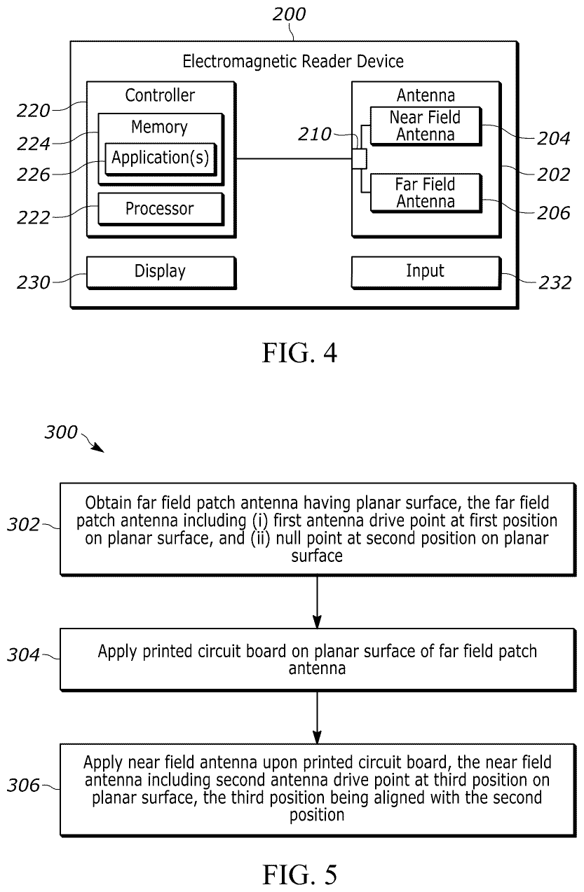

Moving to FIG. 4, a block diagram of an example electromagnetic reader device 200 is provided. The electromagnetic reader device 200 may, for example, be an RFID reader (e.g., a handheld RFID reader) used to scan or otherwise detect items in an environment. However, various other embodiments and applications of the electromagnetic reader device 200 may be contemplated from this disclosure. In various embodiments, the electromagnetic reader device 200 may include additional, fewer, and/or alternate components to those shown in FIG. 4.

As depicted in FIG. 4, the electromagnetic reader device 200 includes an antenna 202, e.g., the integrated antenna 100 as described with respect to FIGS. 1-3. The antenna 202 includes a near field antenna 204 (e.g., near field antenna 130) and a far field antenna 206 (e.g., far field antenna 110). The antenna 202 may further include a switch 210, controllable to change operation of the antenna 202 between operating (e.g., radiating from and/or detecting by) the near field antenna 204 and far field antenna 206. That is, in one mode of operation, responsive to a controller controlling the switch 210, the antenna 202 is made to operate the near field antenna 204 and not the far field antenna 206, whereas in another mode of operation the antenna 202 is made to operate the far field antenna 206 and not the near field antenna 204 (with the switch 210 alternating the antenna 202 between the two modes of operation). In some implementations, in still another mode(s), the switch can cause the antenna 202 to operate both the near field antenna 204 and far field antenna 206, or in other cases, neither the near field antenna 204 nor the far field antenna 206. Switching between modes may take effect within several microseconds.

The electromagnetic reader device 200 further includes a controller 220, which may include a processor 222 (i.e., one or more processors) and a memory 224 (i.e., one or more memories) and may control operation of the switch 210. The memory 224 may include various types of memory, e.g., ROM, RAM, EPROM, EEPROM, etc. The non-transitory portions of the memory 224 may include one or more applications 226 storing instructions that, when executed by the processor 222, cause the electromagnetic reader device 200 to perform actions including, but not limited to, operating the switch 210 to switch modes of operation of the antenna 202 at predetermined time intervals and/or based on other criteria.

In embodiments, the electromagnetic reader device 200 includes a display 230 (i.e., one or more displays) and an input 232 (i.e., one or more inputs). The display 230 generally includes one or more components configured to output information to a user, e.g., a screen (for example, a touchscreen), a speaker, a haptic output device, etc. The input 232 generally includes one or more components configured to receive information from a user, e.g., a touchscreen, a mouse, a keyboard, a microphone, one or more accelerometers, gyroscopes, or haptic sensors, etc. In embodiments, aspects of the display 230 and input 232 are integrated into a single component (e.g., in an interactive touchscreen). The display 230 and/or input 232 may include one or more components within the electromagnetic reader device 200, or otherwise operatively coupled to the electromagnetic reader device 200 via wired and/or wireless means (e.g., in the case of a mouse, keyboard, standalone display screen, etc.).

In embodiments, the electromagnetic reader device 200 may be implemented in an environment where a user seeks to differentiate between entities (e.g., objects) near the electromagnetic reader device 200 (e.g., within a near field range of the near field antenna 204) and entities not in the near field range but otherwise in an environment around the electromagnetic reader device 200 (e.g., within a far field range of the far field antenna 206).

In some embodiments, for example, the electromagnetic reader device 200 may use the switch 210 to operate the antenna 202 in a first mode of operation that operates the far field antenna 206 (and not the near field antenna 204) prior to detecting an entity (e.g., an object such as an RFID tag) by way of the far field antenna 206. The controller 220 may receive identifying information about the detected entity via the far field antenna 206 and may identify the entity based thereupon (e.g., by referencing information stored at the memory 224), and/or by communicating with an external database via wired and/or wireless communications. Responsive to detecting and/or identifying the entity, the controller 220 may switch the antenna 202 to a second mode of operation that operates the near field antenna 204 and not the far field antenna 206. The controller 220 may enable this second mode of operation, for example, in anticipation of the detected entity being within the near field range subsequently to being within the far field range. The electromagnetic reader device 200 may thereafter detect, for example, whether the initially detected entity is detected by the near field antenna 204 before leaving the far field range (e.g., through later reactivation of the far field antenna 206). In some embodiments, operation of the far field antenna 206 may include comparing a received signal strength indicator (RSSI) of the entity to a stored reference value to further determine a distance of the detected entity from the electromagnetic reader device 200.

The electromagnetic reader device 200 may be deployed in various environments for use. For example, the electromagnetic reader device 200 may be integrated into a point of sale (POS) computing device in a checkout area of a retail store. The far field range may, for example, generally correspond to a space comprising the checkout area and/or other defined region of a retail store, e.g., a region near an exit. The POS device may be configured to operate the far field antenna 206 intermittently until detecting the presence of an object (e.g., RFID tag) affixed to a product, thus suggesting the presence of a customer, sales associate, or other who has carried that object into the far field range of the POS device. In some examples, responsive to detecting that object or customer via the far field antenna 206, the POS device may switch the antenna 202 to use the near field antenna 204, which the POS device may use to scan products (e.g., RFID tag) to complete checkout. Responsive to the customer completing checkout (e.g., as detected via payment and/or other at the POS device), the POS device may switch back to operating only the far field antenna 206, thereby conserving power in the POS device by only using the near field antenna 204 upon anticipated need. The POS device example illustrates another advantageous implementation of the electromagnetic reader devices herein, namely an ability to detect one object in the far field using a far field antenna and then be switched to a near field antenna capable of detecting many objects in the near field. That can provide considerable improvements in fast checkout when customers carry numerous products requiring scanning. In any event, after enabling the near field antenna 204, the POS device may briefly and intermittently reactivate (or revert back to) the far field antenna 206, to detect whether the customer and object are no longer within the far field range. If the POS device determines that the customer and/or object are no longer within the far field range again without the near field antenna 204 ever detecting the object, the POS device may be configured to provide a visual, audial, and/or haptic warning (e.g., via the display 230) regarding the determination, as a means of detecting, deterring, and/or notifying of theft. In embodiments, said determinations may be further refined by use of additional antenna elements in the retail store in communication with the POS device, e.g., using an additional one or more antennas in a vicinity of the exit to verify whether the object's leaving the far field range of the POS indicates the object leaving the retail store entirely (or instead, only indicates the customer returning to deeper within the retail store).

Various other implementations may be considered. For example, in some implementations, a far field range may correspond to an event venue such as a theater or stadium, and a near field range may correspond to a ticket selling and/or scanning point in or around the event venue. In still other implementations, the far field range may correspond to a recreational area such as a portion of a ski resort, amusement park, etc., and the near field range may correspond to a scanning point encountered by a person prior to engaging in a particular activity (e.g., a scanning point by which customers scan passes at a chair lift, an entryway of an amusement park attraction, etc.). In each case, implementations may be envisioned that base various suitable actions at least partly on determinations of whether the electromagnetic reader device 200 detects a given object(s) via the near field antenna 204, the far field antenna 206, both antennas, or neither antenna.

Turning now to FIG. 5, an example method 300 is provided for manufacturing an integrated antenna, in accordance with some embodiments. The method 300 may be performed, for example, in a manufacturing facility to manufacture one or more of the integrated antenna 100 as described with respect to FIGS. 1-3. The manufacturing of the integrated antenna according to the method 300 may, for example, enable assembly of a product that contains the integrated antenna (e.g., the electromagnetic reader device 200 of FIG. 4).

The method 300 includes obtaining a far field patch antenna having a planar surface (302). The far field patch antenna may include a first antenna drive point at a first position on the planar surface, and a null point at a second position on the planar surface. The method 300 further includes applying a printed circuit board (PCB) on the planar surface of the far field patch antenna (304). The method 300 still further includes applying a near field antenna upon the PCB (306). The near field antenna may include a second antenna drive point at a third position on the planar surface, and the third position on the planar surface may be aligned with the second position. The near field antenna may, for example, have a resistance of 50 Ohms (e.g., a 50 Ohm microstrip transmission coil).

In some embodiments, the method 300 may further include operatively coupling the antenna to a controller. The controller may be configured to switch operation of the antenna between a first mode corresponding to operation of the far field patch antenna and a second mode corresponding to operation of the near field antenna (e.g., via any suitable technique(s) from among those described in this disclosure).

In some embodiments, the method 300 further includes configuring the antenna to switch between a first mode corresponding to operation of the far field patch antenna and a second mode corresponding to operation of the near field antenna (e.g., at predetermined intervals, and/or based on other criteria described in this disclosure), for example, using the controller.

The method 300 may include still additional, fewer, and/or alternate actions, in various embodiments. Moreover, it should be appreciated that the order of actions in the method 500 may, in embodiments, occur in orders other than that in which the actions were described in the foregoing.

### ADDITIONAL CONSIDERATIONS

In the foregoing specification, specific embodiments/aspects have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations/aspects should not be interpreted as mutually exclusive, and should instead be understood as potentially combinable if such combinations are permissive in any way. In other words, any feature disclosed in any of the aforementioned embodiments, examples, implementations, or aspects may be included in any of the other aforementioned embodiments, examples, implementations, or aspects.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. An antenna comprising:
a far field patch antenna having a planar surface, the far field patch antenna comprising:
a first antenna drive point at a first position on the planar surface, and
a null point at a second position on the planar surface;
a printed circuit board (PCB) disposed on the planar surface of the far field patch antenna; and
a near field antenna disposed on the PCB, the near field antenna comprising a second antenna drive point at a third position on the planar surface, wherein the second antenna drive point at the third position on the planar surface is aligned with the null point at the second position on the planar surface, and
the antenna is configured to switch between a first mode corresponding to operation of the far field patch antenna and a second mode corresponding to operation of the near field antenna.

2. The antenna of claim 1, implemented in an electromagnetic reader device capable of both near field and far field signal detection, the electromagnetic reader device being arranged to exclude each of a standalone far field antenna and a standalone near field antenna.

3. The antenna of claim 1, wherein the near field antenna comprises a microstrip transmission coil originating from the second drive point.

4. The antenna of claim 1, wherein the antenna is operatively coupled to a controller configured to switch operation of the antenna between the first mode corresponding to operation of the far field patch antenna and the second mode corresponding to operation of the near field antenna.

5. The antenna of claim 4, wherein the controller is configured to switch the operation of the antenna at predetermined time intervals.

6. The antenna of claim 4, wherein the first mode of operation comprises identification of an entity as being within a space, and wherein the second mode of operation comprises identification of the entity as being within a portion of the space.

7. The antenna of claim 6, wherein the controller is configured to switch to the second mode of operation responsive to the identification occurring in the first mode of operation.

8. An RFID reader device comprising:
a far field patch antenna having a planar surface, the far field patch antenna comprising:
a first antenna drive point at a first position on the planar surface, and
a null point at a second position on the planar surface;
a printed circuit board (PCB) disposed on the planar surface of the far field patch antenna;
a near field antenna disposed on the PCB, the near field antenna comprising a second antenna drive point at a third position on the planar surface, wherein the second antenna drive point at the third position on the planar surface is aligned with the null point at the second position on the planar surface; and
a controller operatively coupled to each of the far field patch antenna and the near field antenna, the controller comprising:
a processor; and
a memory storing instructions that, when executed, cause the controller to switch operation of the RFID reader between a first mode corresponding to operation of the far field patch antenna and a second mode corresponding to operation of the near field antenna.

9. The RFID reader of claim 8, wherein the RFID reader is arranged to exclude each of a standalone far field antenna and a standalone near field antenna.

10. The RFID reader of claim 8, wherein the near field antenna comprises a microstrip transmission coil originating from the second drive point.

11. The RFID reader of claim 8, wherein the controller is configured to switch the operation of the antenna at predetermined time intervals.

12. The RFID reader of claim 8, wherein the first mode of operation comprises identification of an entity as being within a space, and wherein the second mode of operation comprises identification of the entity as being within a portion of the space.

13. The RFID reader of claim 12, wherein the instructions, when executed by the processor, cause the controller to switch to the second mode of operation responsive to the identification occurring in the first mode of operation.

14. The RFID reader of claim 12, wherein the instructions, when executed by the processor, further cause the controller to, subsequent to switching to the second mode of operation:
revert the RFID reader to the first mode of operation; and
determine that the RFID reader did not detect the entity while operating in the second mode of operation before reverting to the first mode of operation.

15. The RFID reader of claim 14, operatively coupled to a display, and wherein the instructions, when executed by the processor, cause the display to provide a warning regarding the determination that the RFID reader did not detect the entity while operating in the second mode of operation.

16. The RFID reader of claim 8, wherein the operation of the RFID reader in the first mode causes energization of an RFID tag via the far field patch antenna, and wherein the operation of the near field antenna in the second mode comprises reading the RFID tag via the near field antenna after the energization via the far field patch antenna.

17. A method of manufacturing an antenna, the method comprising:
obtaining a far field patch antenna having a planar surface, the far field patch antenna comprising:
a first antenna drive point at a first position on the planar surface, and
a null point at a second position on the planar surface;
applying a printed circuit board (PCB) on the planar surface of the far field patch antenna; and
applying a near field antenna upon the PCB, the near field antenna comprising a second antenna drive point at a third position on the planar surface, wherein the second antenna drive point at the third position on the planar surface is aligned with the null point at the second position on the planar surface.

18. The method of claim 17, further comprising operatively coupling the antenna to a controller configured to switch operation of the antenna between a first mode corresponding to operation of the far field patch antenna and a second mode corresponding to operation of the near field antenna.

19. The method of claim 17, further comprising configuring the antenna to switch between a first mode corresponding to operation of the far field patch antenna and a second mode corresponding to operation of the near field antenna.

20. The method of claim 17, wherein the near field antenna has a resistance of 50 ohms.
